(19) United States
(12) Patent Application Publication
(10) Pub. No.: US 2018/0219386 A1
(43) Pub. Date: Aug. 2, 2018

(54) CHARGING BETWEEN BATTERIES OF DEVICES

(71) Applicant: HEWLETT-PACKARD DEVELOPMENT COMPANY, LP., HOUSTON, TX (US)

(72) Inventor: PETER SIYUAN ZHANG, HOUSTON, TX (US)

(21) Appl. No.: 15/747,208

(22) PCT Filed: Sep. 18, 2015
(86) PCT No.: PCT/US2015/050911

§ 371 Date: Jan. 24, 2018

(51) Int. Cl. H02J 7/00; G06F 1/26

(52) U.S. Cl. CPC H02J 7/0013; G06F 1/263; G06F 1/266

(57) ABSTRACT

In an example implementation according to aspects of the present disclosure, a method may include detecting an external event to indicate a desired directionality of charging between batteries disposed in a first device and a second device. The method further includes determining whether the desired directionality of the charging between the batteries is allowable and, if the desired directionality is allowable, initiating the desired directionality of the charging between the batteries.

### BACKGROUND

The emergence and popularity of mobile computing has made portable computing devices, due to their compact design and light weight, a staple in today's marketplace. Tablet computers are examples of portable computing devices that are widely used. Tablet computers generally employ a touchscreen on a display surface of the device that may be used for both viewing and input. Users of such devices may interact with the touchscreen via finger or stylus gestures. As an example, an on-screen keyboard may be illustrated on the touchscreen surface for entering characters.

### BRIEF DESCRIPTION OF THE DRAWINGS

FIG. 1 illustrates a block diagram of a 2-in-1 device, according to an example;

FIG. 2 is a block diagram illustrating an embedded controller (EC) that may be found in a 2-in-1 device, according to an example; and

FIG. 3 is a flow diagram in accordance with an example of the present disclosure.

### DETAILED DESCRIPTION

As the computing power of portable computing devices, such as tablet computers, continue to increase, users may desire to expand the use of such devices, for example, from solely employing the touchscreen on the display surface of such devices for both viewing and input. As an example, various peripherals may be attachable to the tablet computer and used to expand the use of the portable computing device. Such devices that combine tablet computers with optional peripherals are also known as 2-in-1 devices. An example of such peripherals include, but is not limited to, a keyboard. With regards to a keyboard, there may be instances when users may desire to enter characters via an external, physical keyboard, particularly when creating content or typing for a prolonged period of time (e.g., creating a document, spreadsheet, or slides).

Such peripherals of 2-in-1 devices may have a power source separate from the power source disposed within the tablet computer. As an example, the peripherals may have a battery disposed within, to power the features of the peripherals. As a result, 2-in-1 devices may incorporate a dual battery implementation, with one battery disposed in the tablet computer and the other battery disposed in the peripheral that is attachable to the tablet computer.

Examples disclosed herein provide the ability for battery levels of the batteries disposed in the tablet computer and peripheral of a 2-in-1 device to be optimized according to the need of end users of the 2-in-1 device. As an example, the battery levels of the batteries may be optimized differently according to the usage scenario of each end user. For example, the battery in the tablet computer may be used to charge the battery in the peripheral, for example, if an external device is plugged into a port of the peripheral for charging. Similarly, the battery in the peripheral may be used to charge the battery in the tablet computer, for example, if an end user wants to ensure that the tablet computer has a sufficient charge so that it can be detached from the peripheral. As will be further described, the desired directionality of charge between the batteries disposed in the components of the 2-in-1 device may be triggered by events carried out by an end user.

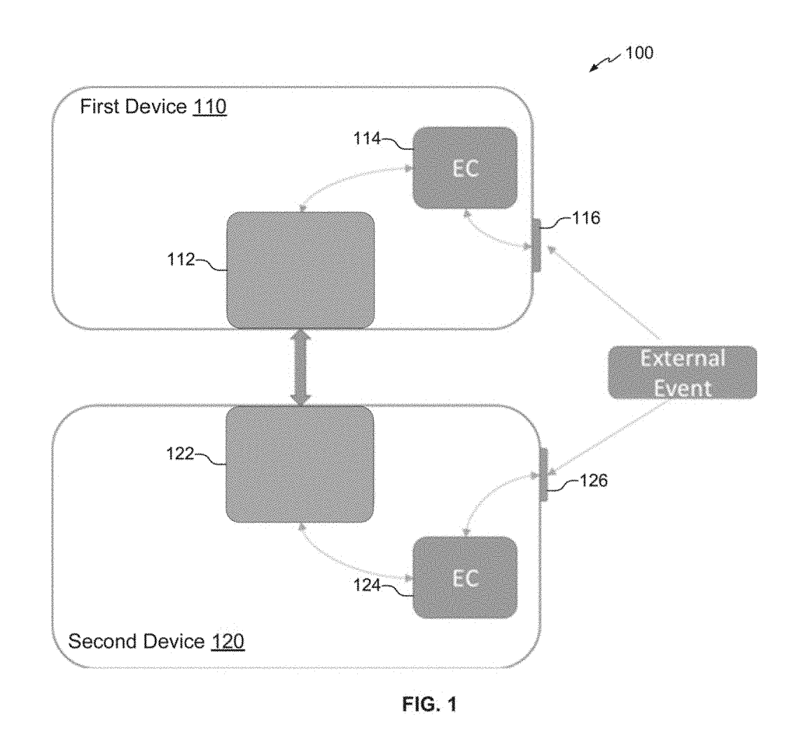

With reference to the figures, FIG. 1 illustrates a block diagram of a 2-in-1 device 100, according to an example. As illustrated, the 2-in-1 device 100 generally includes a first device 110, such as a tablet computer, that is attachable to a second device 120, such as a peripheral, as described above. As an example, the first device 110 may include a display surface (e.g., a touchscreen that may be used for both viewing and input) and a back surface opposite the display surface.

According to an example, the 2-in-1 device 100 incorporates a dual battery implementation, with one battery 112 disposed in the tablet computer 110 and the other battery 122 disposed in the peripheral 120. As a result, each battery 112, 122 may independently power their respective component of the 2-in-1 device 100 (e.g., the tablet computer 110 and the peripheral 120). In addition, the first and second batteries 112, 122 may be used to charge each other, as will be described further below. As an example, the first and second devices 110, 120 may magnetically couple to each other in order to facilitate the charging between the batteries 112, 122. As will be further described, a directionality of charging between the batteries 112, 122, as indicated by an end user of the 2-in-1 device 100, may be detected and implemented, if allowable. For example, if the charge level of one of the batteries 112, 122 is below a threshold amount or reserve battery level, charging from the almost-depleted battery may not be allowed.

As an example, in order to detect an external event implemented by an end user, that indicates a desired directionality of charging between the batteries 112, 122, the first and second devices 110, 120 may include embedded controllers (EC) 114, 124, respectively, in order to detect such events. However, although FIG. 1 illustrates each device 110, 120 having their own EC 114, 124, the 2-in-1 device 100 may instead have a single EC disposed in one of the devices 110, 120 for detecting the desired directionality of charging between the batteries 112, 122. As an example, the events detected by the ECs 114, 124 may correspond to interactions carried out by the end user externally, for example, at location 116 of the first device 110 or location 126 of the second device 120. The locations 116, 126 may correspond, for example, to a button or a port. If either location 116, 126 corresponds to a button, when the button is pressed, the button press may correspond to the desire of an end user to ensure that the battery of the device where the button is pressed is charged, for example, by the battery of the other device.

As an example, if the button at location 116 on the first device 110 is to be pressed, the battery 122 disposed in the second device 120 may charge the battery 112 disposed in the first device 110, based on whether the desired directionality of charging is allowable, as will be further described. If either location 116, 126 corresponds to a port, when an external device, such as a smartphone, is plugged into the port, this may correspond to the desire of the end user to ensure that the battery of the external device is charged. As an example, if the external device is plugged into the port at location 126 of the second device 120, rather than having the battery 122 in the second device 120 drain from charging the external device, the battery 112 in the first device 110 may charge the battery 122 in the second device 120 or be used to directly charge the external device, if allowable, as will be further described.

Upon detecting an external event that indicates a desired directionality of the charging between the batteries 112, 122 disposed in the first and second devices 110, 120, the ECs 114, 124 may determine whether the desired directionality of the charging is allowable. As an example, each EC 114, 124 may determine the charge level of its corresponding battery that it is connected to. For example, EC 114 may determine the charge level of battery 112 of the first device 110, and EC 124 may determine the charge level of battery 122 of the second device 120. If the charge level of one of the batteries 112, 122 is below a threshold amount or reserve battery level, charging from the almost-depleted battery may not be allowed. This threshold amount of reserve battery level may be adjusted by the end user, for example, based on the minimum amount of charge the end user may desire for each device 110, 120 to have.

Continuing with the example described above, if an external device, such as a smartphone, is plugged into the port at location 126 of the second device 120, EC 114 may check whether the charge level of the battery 112 of the first device 110 is above the preset reserve battery level (threshold amount) in order to determine whether the battery 112 can be used to charge battery 122 of the second device 120 or directly charge the battery of the external device. If the charge level of the battery 112 disposed in the first device 110 is below the threshold amount, charging from the battery 112 disposed in the first device 110 to the battery 122 disposed in the second device 120 or the battery of the external device is not allowed. However, if the charge level of the battery 112 disposed in the first device 110 is above the threshold amount, battery 112 may then be used to charge either the battery 122 disposed in the second device 120 or the battery of the external device.

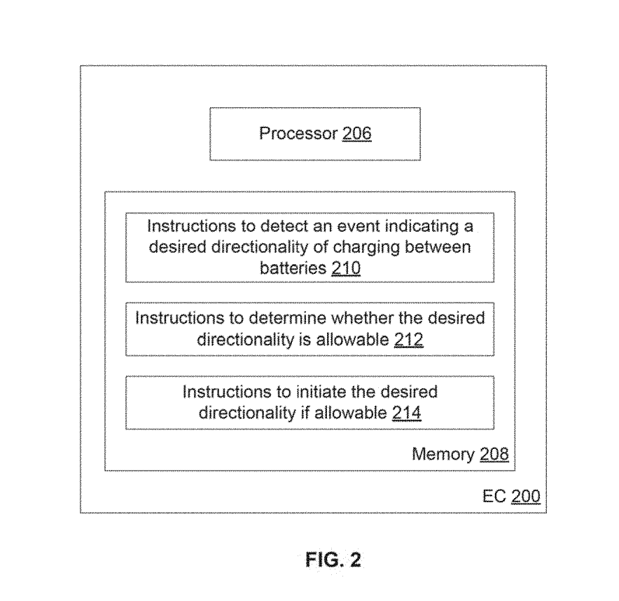

FIG. 2 is a block diagram illustrating an EC 200 that may be found in a 2-in-1 device, according to an example. As described above, the EC 200 may be used to detect the desired directionality of charging between batteries of the 2-in-1 device, and whether such charging is allowable. EC 200 may correspond to EC 114, 124 of FIG. 1. However, a 2-in-1 device may instead have a single EC disposed in one of the devices (e.g., the tablet computer or peripheral) for detecting the desired directionality of charging between batteries.

As illustrated, the EC 200 includes a processor 206 and a memory device 208. The components of the EC 200 may be connected and communicate through a system bus (e.g., PCI, ISA, PCI-Express, HyperTransport®, NuBus, etc.). The processor 206 can be a single core processor, a multi-core processor, a computing cluster, or any number of other configurations. The processor 206 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 208 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems comprising (e.g., encoded with) instructions 210, 212, and 214. In some examples, the memory device 208 may include additional instructions. As an example, memory device 208 may be a non-transitory machine-readable storage medium. The processor 206 may fetch, decode, and execute instructions stored on the memory device 208 to implement the functionalities described herein.

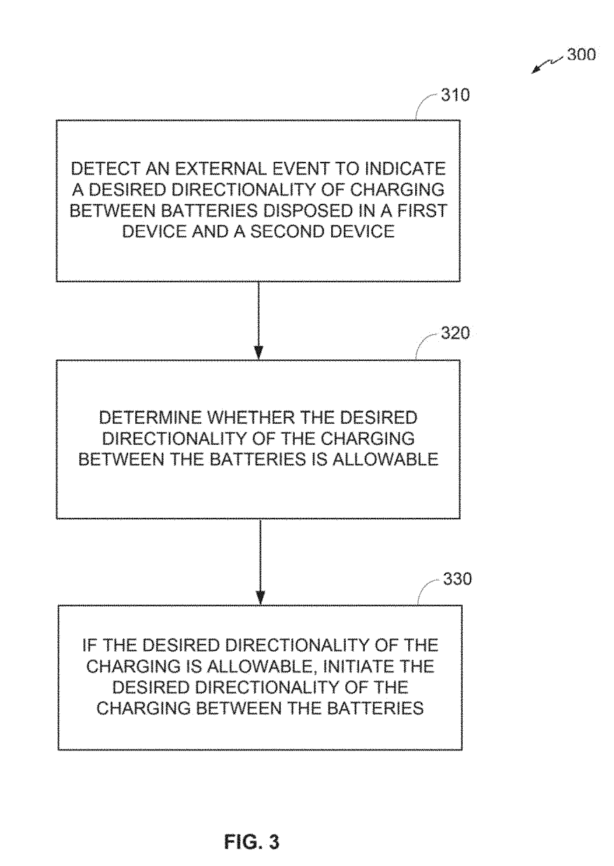

Referring to FIG. 3, a flow diagram is illustrated in accordance with various examples. The flow diagram illustrates, in a particular order, processes for optimizing the charge level of batteries in devices of a 2-in-1 device, such as a tablet computer and peripheral. The order of the processes is not meant to limit the disclosure. Rather, it is expressly intended that one or more of the processes may occur in other orders or simultaneously. The disclosure is not to be limited to a particular example.

A method 300 may begin and progress to 310, where the 2-in-1 device may detect an external event to indicate a desired directionality of charging between the batteries disposed in a first device and a second device of the 2-in-1 device. Examples of external events include when a button on either the first or second device is to be pressed, or when a third device is to be plugged into a port of either the first or second device.

Progressing to 320, the 2-in-1 device may determine whether the desired directionality of the charging between the batteries is allowable. For example, when the button on the first device is to be pressed, the battery disposed in the second device is to charge the battery disposed in the first device if the desired directionality of charging from the battery disposed in the second device to the battery disposed in the first device is allowable.

As an example of determining whether the desired directionality of charging between the batteries of the first and second device is allowable, the charge level of the battery performing the charging is checked. If the charge level of the battery disposed in, for example, the first device, is below a threshold amount, charging from the battery disposed in the first device to the battery disposed in the second device is not allowed. As an example, when a third device is to be plugged, for example, into the port of the second device, the battery disposed in the first device is to charge the battery disposed in the second device or directly charge the battery disposed in the third device, if the charge level of the battery disposed in the first device is above the threshold amount. Progressing to 330, if the desired directionality of the charging is allowable, the 2-in-1 device may initiate the desired directionality of the charging between the batteries.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method to control directionality of charging between batteries disposed in a first device and a second device, the method comprising:
detecting an external event to indicate a desired directionality of the charging between the batteries disposed in the first and second devices;
determining whether the desired directionality of the charging between the batteries is allowable; and
if the desired directionality of the charging is allowable, initiating the desired directionality of the charging between the batteries.

2. The method of claim 1, wherein the external event comprises a button to be pressed on either the first device or the second device.

3. The method of claim 2, wherein when the button on the first device is to be pressed, the battery disposed in the second device is to charge the battery disposed in the first device if the desired directionality of charging from the battery disposed in the second device to the battery disposed in the first device is allowable.

4. The method of claim 1, wherein the external event comprises a third device to be plugged into a port of either the first device or the second device.

5. The method of claim 4, wherein when the third device is to be plugged into the port of the second device, the battery disposed in the first device is to charge the battery disposed in the second device if the desired directionality of charging from the battery disposed in the first device to the battery disposed in the second device is allowable.

6. The method of claim 4, wherein when the third device is to be plugged into the port of the second device, the battery disposed in the first device is to charge a battery disposed in the third device.

7. The method of claim 1, wherein when a charge level of the battery disposed in the first device is below a threshold amount, charging from the battery disposed in the first device to the battery disposed in the second device is not allowed.

8. A system comprising:
a computing device including a display surface and a back surface opposite the display surface, wherein the computing device comprises a first battery to power the computing device;
a peripheral attachable to the computing device, wherein the peripheral comprises a second battery to power the peripheral;
a memory resource; and
a processing resource, wherein a plurality of programming instructions stored in the memory resource, in response to execution of the programming instructions by the processing resource, is to cause the processing resource to:
detect an event to indicate a desired directionality of the charging between the first and second batteries disposed in the computing device and the peripheral, respectively;
determine whether the desired directionality of the charging between the batteries is allowable; and
if the desired directionality of the charging is allowable, initiate the desired directionality of the charging between the first and second batteries.

9. The system of claim 8, wherein the computing device and the peripheral each comprise a button, wherein when either button is to be pressed indicates the event for the desired directionality of the charging between the first and second batteries.

10. The system of claim 9, wherein when the button on the computing device is to be pressed, the battery disposed in the peripheral is to charge the battery disposed in the computing device if the desired directionality of charging from the battery disposed in the peripheral to the battery disposed in the computing device is allowable.

11. The system of claim 8, wherein the event comprises an external device to be plugged into a port of either the computing device or the peripheral.

12. The system of claim 11, wherein when the external device is to be plugged into the port of the peripheral, the battery disposed in the computing device is to charge the battery disposed in the peripheral if the desired directionality of charging from the battery disposed in the computing device to the battery disposed in the peripheral is allowable.

13. A non-transitory machine-readable storage medium comprising instructions executable by a processing resource of a system comprising a computing device and a peripheral attachable to the computing device, the instructions executable to:
detect an event to indicate a desired directionality of charging between batteries disposed in the computing device and the peripheral;
if a charge level of a battery to perform the charging is above a reserve battery level, initiate the desired directionality of the charging between the batteries.

14. The non-transitory storage medium of claim 13, wherein when a charge level of a battery disposed in the computing device is below the reserve battery level, charging from the battery disposed in the computing device to a battery disposed in the peripheral is not allowed.

15. The non-transitory storage medium of claim 13, wherein the event comprises a button to be pressed or an external device to be plugged into a port of either the computing device or the peripheral.
